(19) United States
(12) Patent Application Publication
(10) Pub. No.: US 2004/0114665 A1
(43) Pub. Date: Jun. 17, 2004

(54) Cantilevered thermocouple rake

(76) Inventors: Sun Park, Woburn, MA (US); Scott Bittman, New City, NY (US)

Correspondence Address: Attention of Kevin M. Drucker, HAYES SOLOWAY P.C., 130 W. Cushing Street, Tucson, AZ, 85701, US

(21) Appl. No.: 10/317,692

(22) Filed: Dec. 12, 2002

(51) Int. Cl. G01K 1/00; G01K 7/00

(52) U.S. Cl. 374/179; 374/208

(57) ABSTRACT

The present invention provides a thermocouple rake that may readily be removed and reinstalled into a separate turbine. Further, a cantilevered thermocouple rake is provided, wherein the installed rake requires fixation at only one end. A thermocouple rake consistent with the invention also comprises a plurality of rigid guide and support tubes for strength and stiffness, and comprises a plurality of thermocouple junctions in each guide tube at different lengths along the tube, for taking readings at various distances from the turbine wall. The present invention further provides a thermocouple rake having tubing of various diameters to protect against vortex shedding. A plurality of spacers serve as damping during vibration allowing the rake (or at least a portion thereof) to survive vibration at its natural frequency. A stop and tapered bushing configuration effects better damping and longevity in high vibration environments, e.g., in gas turbines. Further, the tapered surfaces used in the stop mechanism allow easy disengagement during transient thermal growth, thereby minimizing thermal stress due to thermal expansion.

### BACKGROUND OF THE INVENTION

The present invention relates to temperature measurement technology, and more specifically, to a multi-element thermocouple rake and probe assembly. Particular utility for the present invention is found in temperature measurement in land gas turbines.

In order to determine the thermodynamic characteristics of a flow, it is necessary to find the Total Pressure (Pₜ), the Static Pressure (Pₛ) and the Static Temperature (Tₛ). In practice, it is difficult to measure the Static Temperature. To overcome this difficulty, it is common to measure the Total Temperature (Tₜ) and use adiabatic equations to determine the Static Temperature, e.g., Tₛ/Tₜ=(Pₜ/Pₛ)^{k-1/k}, where k is the ratio of specific heats of the fluid. The Total Temperature is typically measured by a thermocouple comprising two dissimilar metals, joined together at one end, which produce a small unique voltage at a given temperature. This voltage may then be measured and interpreted by a thermocouple thermometer. Thermocouple assemblies for use in gas turbine engines typically have to withstand high temperatures and high levels of vibration.

Thermocouple rake devices are known in the art, and are generally provided as temperature measurement mechanisms for high temperature and/or high air flow environments, such as turbine engines. As a general matter, thermocouple rake devices include a plurality of thermocouples arranged at different distances along the length of the rake, and exposed to the airflow in a turbine engine to measure temperature.

For example, a thermocouple rake device is described in U.S. patent application Ser. No. 09/969,092, entitled “Rake Thermocouple”, assigned to the same assignee as the present invention, and hereby incorporated by reference in its entirety. This application discloses a thermocouple probe assembly that includes at least one ball bushing placed along the length of the assembly to dampen vibrations and thereby reduce mechanical stress on the assembly. A rake thermocouple is provided that includes a plurality of probe tubes arranged parallel to one another, and each probe assembly is placed into an individual probe tube. Each probe tube has a window defined therein, and an inlet port extending from the window generally perpendicular to the probe tube. The probe tubes themselves also have windows so that there can be air exposure at multiple locations per probe tube. The rake also includes a mated end cap and cup bushing with a defined gap between the inside diameter of the cup bushing and the outside diameter of the end cap to further dampen mechanical stress on the rake. The rake, being fixed at both ends in its installation, may not be readily removable once installed.

Other problems with thermocouples and/or rakes include failure for a number of reasons. One problem with conventional thermocouples and/or rake devices is vortex shedding, wherein alternating low pressure zones are generated in the region of the thermocouple and/or rake. These alternating low pressure zones cause the thermocouple and/or rake to move towards the low pressure zone, causing movement perpendicular to the direction of the flow. When the vortex frequency of the thermocouple and/or rake is close to the natural frequency, these forces can cause the thermocouple and/or rake to resonate and deform. Due to the variability of vibration of gas turbines, the rake and/or thermocouple must be able to withstand vibration in all directions and at their natural frequency, which should cause the largest deformation. Other malfunction or deformation (e.g., fracture) of thermocouples and/or rakes from stress vibrations and/or thermal influences may also occur in turbine environments. Further, many rake devices for turbines are designed for permanent installation and cannot easily be removed and reinstalled into another turbine. Likewise, many thermocouples cannot easily be removed from rakes. Additionally, prior art thermocouples and/or rakes are fixed at both ends (i.e., where the thermocouple or rake is long enough to reach across the entire exhaust area), wherein an inner and an outer member are both disposed in the exhaust area of a turbine. In this scenario, if both members expand at different rates, then stress will be placed on both ends of the thermocouple or rake, making it difficult to survive the harsh environment of the exhaust area, and thereby shortening the life of the thermocouple or rake.

### SUMMARY OF THE INVENTION

The present invention thereby provides a thermocouple rake that may readily be removed and reinstalled into a separate turbine. Further, a cantilevered thermocouple rake is provided, wherein the installed rake requires fixation at only one end. A thermocouple rake consistent with the invention also holds a plurality of rigid guide and support tubes for strength and stiffness, and holds a plurality of thermocouple junctions in each guide tube at different lengths along the tube, for taking readings at various distances from the turbine wall. The present invention further provides a thermocouple rake having pipes and tubes of various diameters and lengths to protect against vortex shedding. A plurality of spacers serve as damping during vibration allowing the rake (or at least a portion thereof) to survive vibration at its natural frequency. A stop and tapered bushing configuration effects better longevity in high vibration environments, e.g., in gas turbines. Further, the tapered surfaces used in the stop mechanism allow easy disengagement during transient thermal growth, thereby minimizing thermal stress due to thermal expansion. The stop also serves to locate the thermocouple junctions after insertion into the rake at their proper immersion depths.

A thermocouple rake consistent with the present invention comprises a plurality of rigid guide tubes, each guide tube housing at least one thermocouple probe assembly comprising at least one thermocouple junction, wherein at least one guide tube varies in length and/or width from the remaining guide tubes. In another aspect, the rake is adapted for fixation at only one end. The rake may further comprise at least one support tube housing at least a portion of at least one guide tube, and at least one spacer adapted to fit inside the support tube. Clearance may be provided between the spacer and support tube, and may be about 0.0125 times the inside diameter of support tube.

The guide tube may contain one or more bushings adapted to fit within the guide tube with a defined gap between the bushing and the inside diameter of the guide tube. The bushing may be at a location at which it is adapted to dampen vibration of at least a portion of the rake. The bushing may be located at a peak mechanical resonance point with respect to at least a portion of the rake. The spacer may be at a location at which it is adapted to dampen vibration of at least a portion of the rake. The spacer may be located at a peak mechanical resonance point with respect to at least a portion of the rake.

The thermocouple probe assembly may further comprise a tapered bushing nearby at least one thermocouple junction. The rake may further comprise a tapered stop adapted to mate with the tapered bushing. The thermocouple probe assembly may be removably disposed within the rake and may be secured to the rake through the use of a fitting. At least one guide tube and/or support tube may have at least one window that exposes the junctions to the environment. On the support tubes, there may be at least one inlet port for focusing the air at the junctions and absorbing stress on the windows.

It will be appreciated by those skilled in the art that although the following Detailed Description will proceed with reference being made to preferred embodiments, the present invention is not intended to be limited to these preferred embodiments. Other features and advantages of the present invention will become apparent as the following Detailed Description proceeds, and upon reference to the Drawings, wherein like numerals depict like parts, and wherein:

### BRIEF DESCRIPTION OF THE DRAWINGS

FIG. 1 is a side cross-sectional view of an exemplary thermocouple probe assembly consistent with the present invention;

FIG. 1A is a side view of the exemplary probe assembly of FIG. 1;

FIG. 2 is a side view of an exemplary rake for housing a plurality of thermocouple probe assemblies of the present invention;

FIG. 2A is a top view of the exemplary rake of FIG. 2;

FIG. 2B is a first end view of the exemplary rake of FIG. 2, in the direction of arrow K of FIG. 2;

FIG. 2C is a second end view of the exemplary rake of FIG. 2, in the direction of arrow L of FIG. 2;

FIG. 3 is an internal side view of the exemplary rake of FIG. 2, with support tubes and other outer elements removed;

FIG. 3A is another internal side view of the exemplary rake of FIG. 2, with support tubes and other outer elements removed;

FIG. 3B is another internal side view of the exemplary rake of FIG. 2, with support tubes and other outer elements removed; and

FIG. 4 is an exploded perspective view of the exemplary rake of FIG. 2 in an exemplary installation into a turbine wall.

### DETAILED DESCRIPTION OF EXEMPLARY EMBODIMENTS

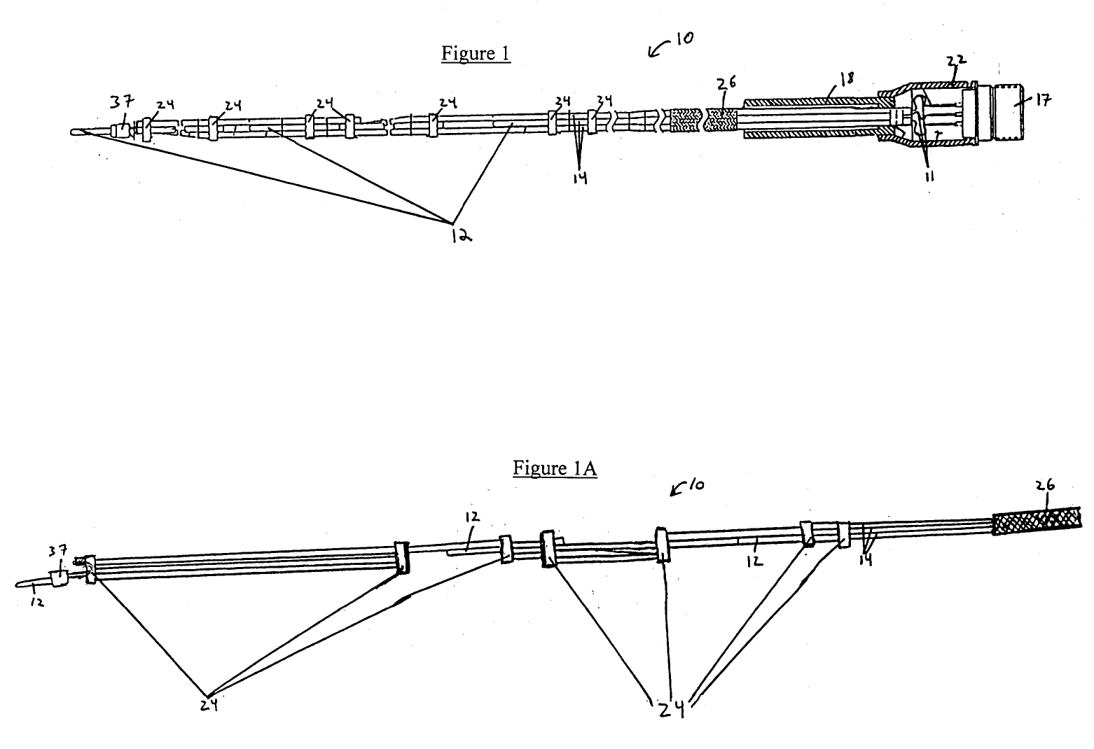

FIG. 1 depicts a thermocouple probe assembly 10 according to one exemplary embodiment of the present invention. The thermocouple probe assembly 10 of this exemplary embodiment comprises a plurality of thermocouple probe tips 12, each containing a thermocouple junction (not shown). A plurality of (e.g., 3) cables 14 house the conductors 11 for the thermocouple junctions, and a plurality of disk bushings 24 are disposed about the cables 14.

Each cable 14 may contain one or more (e.g., 3) thermocouple junctions, thereby providing temperature readings at a plurality of points along the length of each cable 14. The cables 14 are connected to a backshell 22 via an overbraid 26 and an oversheath sleeve (not shown). As will be described below, the disk bushings 24 are used to secure the thermocouple probe assembly 10 into the guide tubes of the rake (not shown) and are appropriately sized to define a gap between the disk bushings 24 and the inside diameter of the guide tubes. The backshell 22 includes one or more connectors 17 to connect the conductors 11 of the thermocouple, e.g., to corresponding high temperature connectors (not shown). A tapered bushing 37 is provided as part of a stop mechanism (described hereinbelow) for locating the probe assembly 10 within the rake. These features will be described in greater detail below.

Referring now to FIG. 1A, further details of the thermocouple probe assembly 10 are provided. The disk bushings 24, which serve to protect the thermocouples during vibration, are placed between the overbraid 26 and the thermocouple probe tips 12, along the length of the cables 14. The cables 14 may comprise a K or K2 type cable, or another type of cable having a metal sheath wherein conductors (e.g., type K conductors) are electrically mineral-insulated from the metal sheath with, e.g., magnesium oxide. The disk bushings 24 protect the probes from wear and reduce deflections by restricting their movement during vibration and achieve this functionality by constantly banging against the guide tubes (not shown), thereby damping vibrations.

The disk bushings 24 may be placed along the length of the cables 14 between a guide tube (not shown) housing the cables 14 and the thermocouple probe tips 12 at peak mechanical resonance points, but it is equally contemplated herein that other points along the length of the apparatus can be chosen in accordance with the present invention. For example, near peak resonant points, or off-peak resonant points may be chosen to provide sufficient mechanical damping, depending on the materials chosen and the desired sensitivity. In the illustrated exemplary embodiment, the disk bushings serve to locate the probe tips at their proper immersion depths and at the centers of the guide tubes. Thus, the present invention is intended to broadly cover the use of disk or other bushings (or equivalents thereof) placed anywhere along the length of the thermocouple probe assembly. In the exemplary embodiment, the cable 14 is formed of mineral insulated cable, which has sufficient flexibility to resist breakage when the entire thermocouple is fixed at only one end (through the use of a fitting and bushing/stop arrangement) and stiff enough to allow the probe tips 12 to be inserted into the guide tubes.

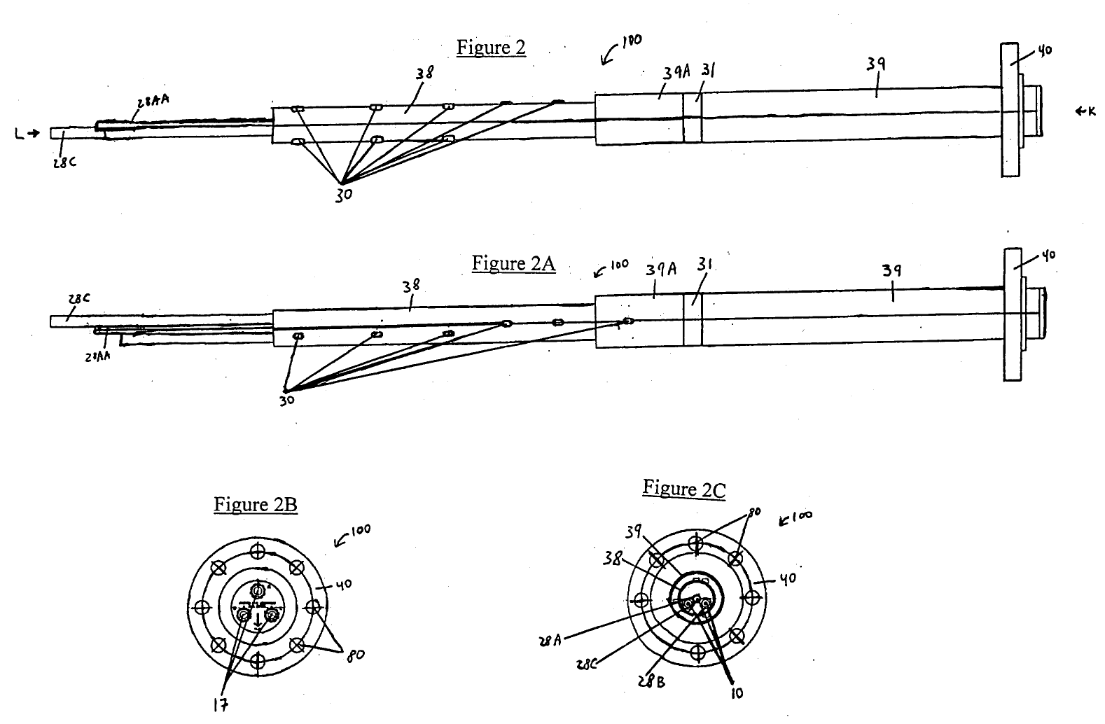

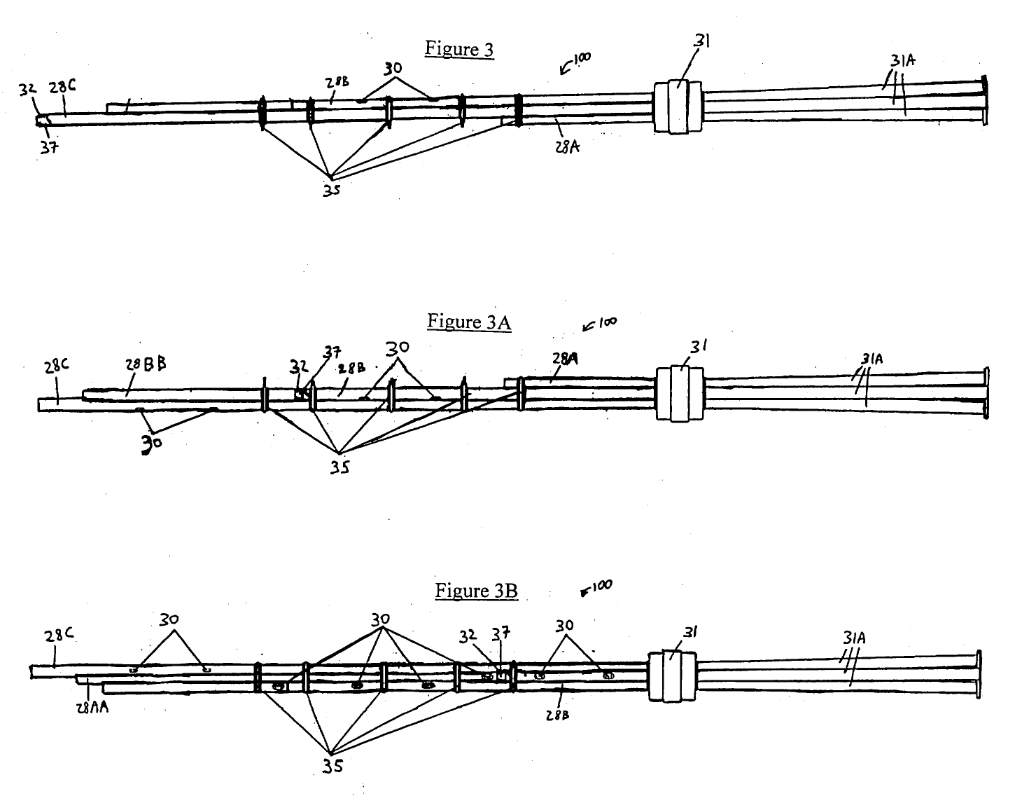

Turning now to FIGS. 2, 2A, 2B, 2C, 3, 3A, and 3B, an exemplary thermocouple rake 100 consistent with the present invention is illustrated. The thermocouple rake assembly 100 houses a plurality of thermocouple probe assemblies 10 (not shown), each disposed within a guide tube 28A, 28B, 28C. The guide tubes 28A, 28B, 28C are arranged generally parallel to one another, and each comprises a generally tubular member having an inside diameter to receive the probes 10 disposed therein. In the exemplary rake 100 shown, the guide tubes 28A, 28B, 28C are oriented as follows: guide tube 28A holds the thermocouple that takes the three temperature readings closest to the turbine wall (not shown); guide tube 28B holds the thermocouple that takes the next three temperature readings away from the turbine wall; and guide tube 28C holds the thermocouples at the three furthest locations from the turbine wall.

The support tubes 38, 39, 39A and guide tubes 28A, 28B, 28C are of varying length and diameter from one another. By employing tubing and piping of differing diameters, vortex shedding problems are reduced, as the different vortexes disrupt one another, and the resultant vortex shedding is not as strong. The support tubes 38, 39, 39A are provided to add strength and stiffness to the rake 100. Since each thermocouple probe assembly 10 is independent of the others in the rake, the present invention improves cost and efficiency by permitting individual probe assemblies to be removed and/or repaired instead of having to remove all the probe assemblies. A plurality of inlets 30 are located on support tubes 38, 39, 39A and may comprise apertures and/or annular members formed within the support tubes 38, 39, 39A and/or other means for exposing the thermocouple junctions to the environment. Such inlets may also be located on the guide tubes, in other embodiments consistent with the invention. By providing a plurality of inlets, the stress in the support tubes caused by the windows is relieved.

With reference now to FIGS. 3, 3A, and 3B, the lower-level assembly of the guide tubes 28A, 28B, 28C is illustrated from three different rotated views. A mid-flange 31 holds and supports the guide tubes 28A, 28B, 28C. The mid-flange 31 combines support tubes 39 and 39A and 31A, which sits in support tube 39 (and is desirably not permanently attached because of thermal expansion). Housed within each guide tube 28A, 28B, 28C, is a tapered bushing 37 adapted to mate with a tapered stop 32 formed within the guide tube 28A, 28B, 28C. Thus, when tapered bushing 37 and stop 32 are mated together, a stop mechanism is formed. A fitting (not shown) secures each thermocouple probe assembly to the thermocouple rake. The stop mechanism is provided in the exemplary embodiment to locate each measurement location, and additionally serves to allow each thermocouple probe assembly to be independent from other probe assemblies.

Further, a plurality of spacers 35 are placed between the mounting flange 31 and the distal ends of the guide tubes 28A, 28B, 28C, along the length of, and welded to, the guide tubes 28A, 28B, 28C. The guide tubes 28A, 28B, 28C are also spot welded (or otherwise attached, e.g., fillet welded) to one another along the length of the rake to hold the guide tubes 28A, 28B, 28C together. The spacers 35 (or other similarly functioning bushings or other such devices) are used to secure the guide tubes 28A, 28B, 28C into support tube 38 (not shown) and are appropriately sized to fit therein, with a narrow clearance. For example, the amount of clearance may be 0.025 inches of clearance in a support tube 38 having a 2 inch diameter, or approximately a ratio of 1/80 times the inner diameter of the support tube. The spacers serve as damping during vibration and to lower the stress on the rake significantly, allowing it to survive vibration at its natural frequency. Securing the probe assembly with the spacers 35 and the stop 32 and tapered bushing 37 effects better damping and longevity in high vibration environments observed in the gas turbines. Tapered surfaces are used in the stop mechanism to allow easy disengagement during transient thermal growth. This minimizes thermal stress due to thermal expansion.

It is noted that, as shown in FIGS. 3A and 3B, additional “dummy” tubing or lengths of tubing may be provided for additional strength and stiffening, e.g., dummy stiffener tubes 28BB (which is an extension of guide tube 28B, wherein the thermocouple stops at stop 32 but the tube continues to extend beyond the stop 32) and 28AA (which is a tube that does not contain a thermocouple) In the exemplary embodiment illustrated herein, the three guide tubes 28A, 28B, 28C are positioned in a triangular arrangement. A triangular arrangement allows each independent thermocouple probe assembly exposure to the flow of air while reducing the cross-sectional diameter of the rake. Other arrangements can be provided without departing from the scope of the present invention, and the present invention is not intended to be limited to this arrangement, as those skilled in the art will recognize that the present invention is not limited to the number of guide tubes used.

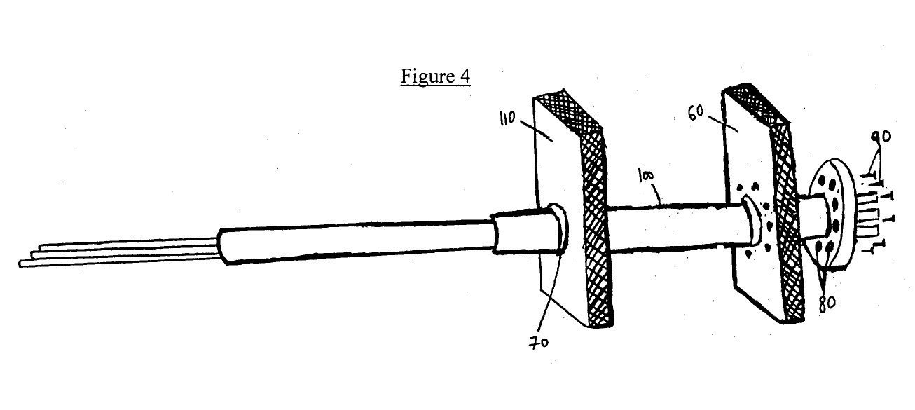

FIG. 4 illustrates an exemplary installation for the exemplary thermocouple rake 100 described hereinabove. As shown, the rake 100 is cantilevered and is fixed in two locations. The rake 100 is fixed to a location 60 outside the turbine wall using a plurality of bolts 90 through bolt holes 80. The rake 100 is further fixed at the inner wall of the turbine 110 using shims (not shown) tack welded onto the rake, to ensure a tight fit where it sits in a hole 70 in the turbine wall. This method of fixation is temporary, rather than permanent, so that the rake 100 can readily be removed after a specified amount of time and remounted into a separate turbine. While the rake of the present invention is described herein as being cantilevered and only fixed at one end, it should be recognized that a rake consistent with the invention may alternatively be adapted for fixation at both ends. Further, although the present application generally refers to a “tapered bushing” and mated “tapered stop”, it should be recognized that the stop and bushing do not necessarily have to be tapered and may be of any shape, size, or other physical configuration sufficient to create a stop mechanism between the bushing and the stop. Finally, while the bushing is described herein as part of the thermocouple probe assembly, it should be recognized that, in alternative embodiments, the bushing could also be part of the guide tube.

Those skilled in the art will recognize numerous modifications to the present invention, and all such modifications are deemed within the scope of the present invention, only as limited by the claims hereinafter appended.

What is claimed is:

1. A thermocouple rake comprising:
at least one thermocouple probe assembly, said thermocouple probe assembly comprising at least one thermocouple junction and a probe tip housing said thermocouple junction;
a plurality of rigid guide tubes, each said guide tube housing at least one said thermocouple probe assembly, wherein at least one said guide tube varies in length and/or width from at least one other of said guide tubes;
at least one support tube housing at least a portion of at least one said guide tube; and
at least one spacer adapted to fit inside said support tube, said spacer supporting at least one said guide tube within said support tube.

2. A thermocouple rake as claimed in claim 1, wherein said rake is adapted for fixation at only one end.

3. A thermocouple rake as claimed in claim 1, wherein said rake is a cantilever beam adapted for support at only one end and without any support at the free end thereof.

4. A thermocouple rake as clamed in claim 1, further comprising at least one bushing, wherein at least one said guide tube contains said bushing.

5. A thermocouple rake as claimed in claim 1, wherein clearance is provided between said spacer and said support tube.

6. A thermocouple rake as claimed in claim 5, wherein said clearance is about 0.0125 times the inside diameter of said support tube.

7. A thermocouple rake as claimed in claim 5, wherein said clearance is based on the natural frequency of said support tube and/or a predetermined amount of damping.

8. A thermocouple rake as claimed in claim 4, wherein said bushing is adapted to fit snugly within said guide tube.

9. A thermocouple rake as claimed in claim 4, wherein said bushing is at a location at which said bushing is adapted to dampen vibration of at least a portion of said rake.

10. A thermocouple rake as claimed in claim 4, wherein said bushing is located at a mechanical resonance point with respect to at least a portion of said rake.

11. A thermocouple rake as claimed in claim 10, wherein said mechanical resonance point is a peak mechanical resonance point.

12. A thermocouple rake as claimed in claim 1, further comprising a depth location bushing adapted to locate the immersion depth of said thermocouple probe assembly, wherein said thermocouple probe assembly is coupled to said depth location bushing.

13. A thermocouple rake as claimed in claim 1, wherein said spacer is at a location at which said spacer is adapted to dampen vibration of at least a portion of said rake.

14. A thermocouple rake as claimed in claim 1, wherein said spacer is located at a mechanical resonance point with respect to at least a portion of said rake.

15. A thermocouple rake as claimed in claim 14, wherein said mechanical resonance point is a peak mechanical resonance point.

16. A thermocouple rake as claimed in claim 1, wherein said thermocouple probe assembly further comprises a stop bushing adjacent at least one said thermocouple junction.

17. A thermocouple rake as claimed in claim 15, wherein said stop bushing is tapered.

18. A thermocouple rake as claimed in claim 15, wherein said rake further comprises a stop adapted to mate with said stop bushing.

19. A thermocouple rake as claimed in claim 1, wherein said thermocouple probe assembly is removably disposed within said rake.

20. A thermocouple rake as claimed in claim 1, wherein at least one said guide tube and/or support tube has an inlet formed therein.

21. A thermocouple rake as claimed in claim 1, wherein at least one said guide tube and/or support tube has a window formed therein and an inlet port coupled to said window, wherein said inlet port is adapted to absorb stress from said window.

22. A thermocouple rake as claimed in claim 20, wherein said inlet is an inlet port adapted to guide the flow to the thermocouple probe assembly and/or junction.

23. A thermocouple rake comprising:
a thermocouple probe assembly comprising at least one rigid tube housing and at least one thermocouple junction;
at least one support tube housing at least a portion of at least one said rigid tube; and
at least one spacer adapted to fit inside said support tube, said spacer supporting at least one said rigid tube within said support tube.

24. A thermocouple rake as claimed in claim 23, wherein said rake is a cantilever beam adapted for support at only one end and without any support at the free end thereof.

25. A thermocouple rake as claimed in claim 23, wherein at least one said rigid tube varies in length and/or width from at least one other of said rigid tubes.

26. A thermocouple rake as claimed in claim 23, wherein clearance is provided between said spacer and said support tube.

27. A thermocouple rake as claimed in claim 26, wherein said clearance is about 0.0125 times the inside diameter of said support tube.

28. A thermocouple rake as claimed in claim 26, wherein said clearance is based on the natural frequency of said support tube and/or a predetermined amount of damping.

29. A thermocouple rake as clamed in claim 24, further comprising at least one bushing, wherein at least one said rigid tube contains said bushing.

30. A thermocouple rake as claimed in claim 29, wherein said bushing is adapted to fit snugly within said rigid tube.

31. A thermocouple rake as claimed in claim 29, wherein said bushing is at a location at which said bushing is adapted to dampen vibration of at least a portion of said rake.

32. A thermocouple rake as claimed in claim 29, wherein said bushing is located at a mechanical resonance point with respect to at least a portion of said rake.

33. A thermocouple rake as claimed in claim 32, wherein said mechanical resonance point is a peak mechanical resonance point.

34. A thermocouple rake as claimed in claim 23, further comprising a depth location bushing 14 adapted to locate the immersion depth of said thermocouple probe assembly, wherein said thermocouple probe assembly is coupled to said depth location bushing.

35. A thermocouple rake as claimed in claim 23, wherein said spacer is at a location at which said spacer is adapted to dampen vibration of at least a portion of said rake.

36. A thermocouple rake as claimed in claim 23, wherein said spacer is located at a mechanical resonance point with respect to at least a portion of said rake.

37. A thermocouple rake as claimed in claim 36, wherein said mechanical resonance point is a peak mechanical resonance point.

38. A thermocouple rake as claimed in claim 23, wherein said thermocouple probe assembly further comprises a stop bushing adjacent at least one said thermocouple junction.

39. A thermocouple rake as claimed in claim 38, wherein said stop bushing is tapered.

40. A thermocouple rake as claimed in claim 38, wherein said rake further comprises a stop adapted to mate with said bushing.

41. A thermocouple rake as claimed in claim 23, wherein said thermocouple probe assembly is removably disposed within said rake.

42. A thermocouple rake as claimed in claim 23, wherein at least one said rigid tube and/or support tube has an inlet formed therein.

43. A thermocouple rake as claimed in claim 23, wherein at least one said rigid tube and/or support tube has a window formed therein and an inlet port coupled to said window, wherein said inlet port is adapted to absorb stress from said window.

44. A thermocouple rake as claimed in claim 42, wherein said inlet is an inlet port adapted to guide the flow to the thermocouple probe assembly and/or junction.

45. A thermocouple rake comprising:
a thermocouple probe assembly comprising at least one thermocouple junction;
at least one guide tube and at least one bushing, said guide tube housing said thermocouple probe assembly and said bushing;
at least one support tube housing at least a portion of at least one said guide tube; and
at least one spacer adapted to fit inside said support tube, said spacer supporting at least one said guide tube within said support tube.

46. A thermocouple rake as claimed in claim 45, wherein at least one said guide tube varies in length and/or width from at least one other of said guide tubes.

47. A thermocouple rake as claimed in claim 45, wherein clearance is provided between said spacer and said support tube.

48. A thermocouple rake as claimed in claim 47, wherein said clearance is about 0.0125 times the inside diameter of said support tube.

49. A thermocouple rake as claimed in claim 47, wherein said clearance is based on the natural frequency of said support tube and/or a predetermined amount of damping.

50. A thermocouple rake as clamed in claim 45, wherein said rake is a cantilever beam adapted for support at only one end and without any support at the free end thereof.

51. A thermocouple rake as claimed in claim 45, wherein said bushing is adapted to fit snugly within said guide tube.

52. A thermocouple rake as claimed in claim 45, wherein said bushing is at a location at which said bushing is adapted to dampen vibration of at least a portion of said rake.

53. A thermocouple rake as claimed in claim 45, wherein said bushing is located at a mechanical resonance point with respect to at least a portion of said rake.

54. A thermocouple rake as claimed in claim 53, wherein said mechanical resonance point is a peak mechanical resonance point.

55. A thermocouple rake as claimed in claim 45, further comprising a depth location bushing adapted to locate the immersion depth of said thermocouple probe assembly, wherein said thermocouple probe assembly contains said depth location bushing.

56. A thermocouple rake as claimed in claim 45, wherein said spacer is at a location at which said spacer is adapted to dampen vibration of at least a portion of said rake.

57. A thermocouple rake as claimed in claim 45, wherein said spacer is located at a mechanical resonance point with respect to at least a portion of said rake.

58. A thermocouple rake as claimed in claim 57, wherein said mechanical resonance point is a peak mechanical resonance point.

59. A thermocouple rake as claimed in claim 45, wherein said thermocouple probe assembly further comprises a stop bushing adjacent at least one said thermocouple junction.

60. A thermocouple rake as claimed in claim 59, wherein said stop bushing is tapered.

61. A thermocouple rake as claimed in claim 59, wherein said rake further comprises a stop adapted to mate with said bushing.

62. A thermocouple rake as claimed in claim 45, wherein said thermocouple probe assembly is removably disposed within said rake.

63. A thermocouple rake as claimed in claim 45, wherein at least one said guide tube and/or support tube has an inlet formed therein.

64. A thermocouple rake as claimed in claim 45, wherein at least one said guide tube and/or support tube has a window formed therein and an inlet port coupled to said window, wherein said inlet port is adapted to absorb stress from said window.

65. A thermocouple rake as claimed in claim 63, wherein said inlet is an inlet port adapted to guide the flow to the thermocouple probe assembly and/or junction.
